(19) United States
(12) Patent Application Publication
(10) Pub. No.: US 2026/0219361 A1
(43) Pub. Date: Jul. 30, 2026

(54) Systems and Methods Providing Time of Flight Detection with Time-To-Digital Converter Reconstruction of Signal

(71) Applicant: TEXAS INSTRUMENTS INCORPORATED, Dallas, TX (US)

(72) Inventor: Matthieu Chevrier, Freising (DE)

(21) Appl. No.: 19/039,745

(22) Filed: Jan. 28, 2025

(51) Int. Cl. G01S 7/295; G01S 7/40; G01S 13/89

(52) U.S. Cl. CPC G01S 7/295; G01S 7/4021; G01S 13/89

(57) ABSTRACT

A system includes a radio frequency (RF) receive path, which is configured to receive a reflection of a transmitted signal. The signal may include a pulse train having rising edges and falling edges. The RF receive path may process the received signal using one or more time-to-digital converters (TDCs). The output of the TDCs may be used to reconstruct an image of the transmitted signal. The system may further include a time domain (TD) cross-correlation function circuit that is configured to perform a TD cross-correlation function on the transmitted signal and on the reconstructed image. The result of the TD cross-correlation function may indicate a time of flight.

### TECHNICAL FIELD

This disclosure relates generally to signal reconstruction and, more specifically, to the signal reconstruction using a time-to-digital converter (TDC).

### BACKGROUND

The use of radars in automotive and industrial applications is evolving rapidly. Radar finds use in number of applications associated with a vehicle such as collision warning, blind spot warning, lane change assist, parking assist and rear collision warning. In industrial environment, radar finds use in determining relative position and relative velocity of obstacles around the radar. Pulse radar and FMCW (Frequency Modulated Continuous Wave) radar are example radar technologies that may be used in such applications.

### SUMMARY

In an arrangement, a method includes: transmitting a first signal; receiving a second signal, wherein the second signal comprises a reflection of the first signal; processing the second signal, including identifying a first time associated with a first rising edge and a second time associated with a first falling edge; generating a reconstructed signal from the first time and the second time; performing a time domain (TD) cross-correlation function on the first signal and the reconstructed signal; and identifying a time-of-flight between the first signal and the second signal based on the TD cross-correlation function.

In an arrangement, a system includes: a transmit path including: a pulse train generator circuit configured to generate a series of pulses; and a first radio frequency (RF) circuit coupled to the pulse train generator and configured to transmit the series of pulses; a receive path including: a second RF circuit configured to receive a reflection of the series of pulses; a time-to-digital converter (TDC) configured to generate time data, including first time data indicating rising edges of the reflection of the series of pulses and second time data indicating falling edges of the reflection of the series of pulses; a pulse train reconstruction circuit configured to generate an image of the series of pulses based on the first time data and the second time data; and a time domain (TD) cross-correlation function circuit configured to perform a TD cross-correlation function on the series of pulses and the image of the series of pulses; and a processor core configured to receive an output from the TD cross-correlation function and to determine a time-of-flight based on an output of the TD cross-correlation function circuit.

In an arrangement, a system includes: a time-to-digital converter (TDC) configured to generate time data, including first time data indicating rising edges of a received series of pulses and second time data indicating falling edges of the received series of pulses; a pulse train reconstruction circuit configured to generate an image of the received series of pulses based on the first time data and the second time data; and a time domain (TD) cross-correlation function circuit configured to perform a TD cross-correlation function on a transmitted series of pulses and the image of the received series of pulses.

### BRIEF DESCRIPTION OF THE DRAWINGS

Having thus described the invention in general terms, reference will now be made to the accompanying drawings, wherein:

FIG. 1 is an illustration of an example radar system, according to some embodiments.

FIG. 2 is an illustration of an example slicer circuit, according to some embodiments.

FIG. 3 is an illustration of an example time domain operation, which may be performed by the system of FIG. 1, according to some embodiments.

FIG. 4 is an illustration of an example reconstructed pulse train and an example result of a time domain correlation function, according to some embodiments.

FIG. 5 is an illustration of a time domain error, which may be corrected by an example reconstruction circuit, such as in FIG. 1, according to some embodiments.

FIG. 6 is an illustration of an example method, which may be performed by the system of FIG. 1, according to some embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Various embodiments provide systems that may reconstruct a received signal using a time-to-digital converter (TDC) (or more than one TDC). Such systems may then perform a function, such as time domain cross-correlation function on the reconstructed signal versus a transmitted signal to determine a time of flight. Such systems may find applications in radar, where time-of-flight may be used for further processing steps, such as for distance determination, angle determination, speed determination, and the like.

In one example, a radar system may include a transmit path that has a pulse train generator, which is configured to generate a series of pulses. The transmit path may also include a radio frequency (RF) circuit, such as an RF front end, to transmit the series of pulses over an air medium. As a result, the transmit path may transmit a pulse train. A pulse train may be different from radar chirps used in some other systems. For instance, a pulse train may include a square wave (or approximately square) having a duty cycle that is adjusted pulse-to-pulse according to an algorithm, where the duty cycle determines a width of a given pulse. By contrast, a chirp may include a sinusoid, which increases or decreases in frequency over time. In any event, the pulse train may have recognizable rising edges and falling edges, which would be expected to be absent from chirps.

The pulse train may travel through the air medium and be reflected by a target, where the reflection causes a portion of the energy of the transmitted signal to be directed back through the air medium and toward a receive path of the radar system. The receive path may also include an RF front end, which receives the signal from the air medium. The RF front-end may pass the received signal to further-downstream receive-path components. For example, one implementation may include a slicer coupled to an output of the RF front end, where the slicer may be configured as a filter to reduce at least some of the noise expected to be in the received signal. The slicer may generate a series of rising edges and falling edges, which may correspond to rising edges and falling edges of the transmitted pulse train, though the slicer may also include rising edges and falling edges of some noise.

A TDC may be coupled to the output of the slicer and configured to receive the rising edges and falling edges generated by the slicer. In this example, the TDC may generate time data. For instance, the TDC may generate time data indicating times of rising edges from the slicer and may also generate time data indicating times of falling edges from the slicer. The TDC may include a single TDC that generates time data for both rising edges and falling edges. In another example, the TDC may include a first TDC that generates time data for rising edges and a second TDC that generates time data for falling edges. The TDC may store the time data in a memory circuit, such as registers, random-access memory (RAM), or the like.

Further, in some examples, the TDC may receive a start signal from the transmit path, where the start signal indicates a reference time (TO), which is a time at which the transmit path began transmitting the pulse train. For instance, the reference time TO may correspond to a first rising edge of the pulse train. The TDC may then measure each subsequent rising edge and falling edge with respect to reference time TO, so that each subsequent edge has a larger time value than its preceding edge.

The receive path may further include a pulse train reconstruction circuit, which is configured to generate a pulse train based on the time data from the TDC that corresponds to the transmitted pulse train. For instance, the pulse train reconstruction circuit may use the time data to create a received pulse train, where a given rising edge and a subsequent falling edge may be separated by a time domain portion, and the pulse train reconstruction circuit may assign a value to that time domain portion as a digital one. The pulse train reconstruction circuit may then assign a value of digital zero to another time domain portion between the falling edge and the next rising edge. Of course, the received pulse train may have any appropriate quantity of pulses, and the pulse train reconstruction circuit may then go edge-to-edge assigning digital ones and digital zeros as appropriate. The result of the pulse train reconstruction circuit is then a time domain model of the signal received by the receive RF front end. In some instances, the output of the pulse train reconstruction circuit may include pulses resulting from noise, though it is expected that some or all of the noise would have been filtered by the slicer.

The receive path may further include a time domain (TD) correlation function circuit. The TD correlation function circuit may perform a correlation function (e.g., a TD cross-correlation function) on the known transmitted signal (the transmitted pulse train) and on the received pulse train that is output from the pulse train reconstruction circuit. The TD correlation function may generate a resulting waveform having a spike in correlation that coincides with a time value, where that time value may correspond to a time of flight between the received signal and the transmitted signal. The TD correlation function may have some tolerance for noise, so that even in a situation in which the output of the pulse train reconstruction circuit has noise, the TD correlation function may be expected to have a recognizable spike indicating a time-of-flight.

Various embodiments may include advantages over other systems. For instance, other systems may use analog to digital converters to process received radar chirps, where the output of the analog-to-digital converters may be used by further downstream components to determine phase offset from a transmitted chirp. However, recent trends in radar may move toward higher frequencies, higher bandwidth, and lower power consumption, and some analog-to-digital converters may have power characteristics and nonlinear behavior that may be undesirable in some instances. For instance, higher frequencies and higher bandwidth may cause a system to be more sensitive to nonlinear behavior of analog-to-digital converters. In another example, higher bandwidth performance may cause a system to operate its analog-to-digital converters in a way that uses a relatively large amount of power.

By contrast, various embodiments may use TDCs, which may be able to provide higher frequencies, higher bandwidth, and lower power consumption than some analog-to-digital converters. As a result, various embodiments discussed herein may provide higher frequency performance and higher bandwidth performance with little or no increase in power consumption. Furthermore, the power saving characteristics of some TDC embodiments may allow for longer battery life in radar systems that are powered by batteries.

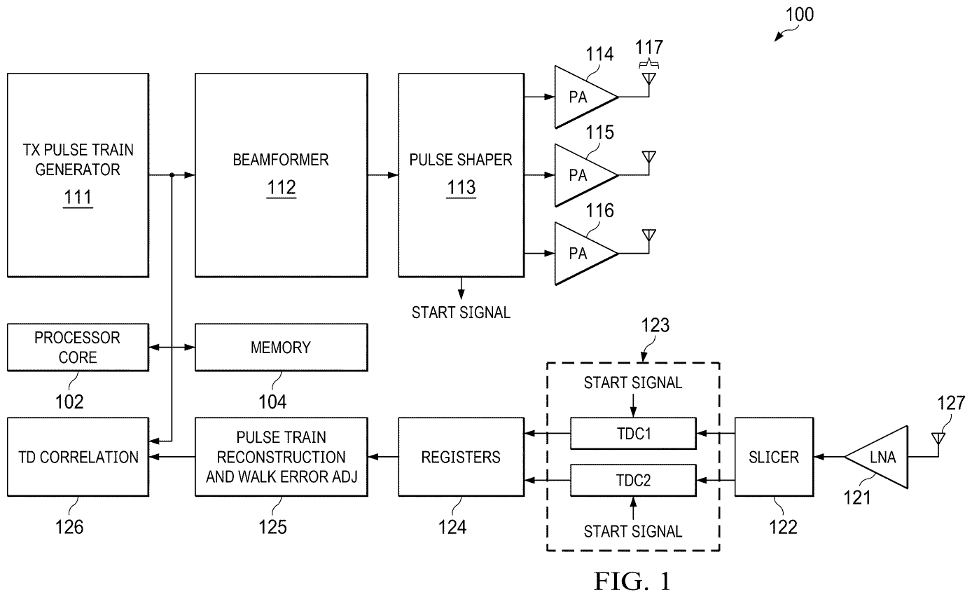

FIG. 1 is an illustration of an example radar system 100, according to various embodiments. System 100 includes processor core 102, which may include any appropriate processor core, such as a reduced instruction set processor core, a general-purpose processor core, a digital signal processor core, a graphics processing unit core, and/or the like. Processor core 102 is coupled to memory 104, which may store computer-readable instructions for execution by the processor core 102. For instance, the processor core 102 may read and execute instructions from the memory 104 to perform various functions, such as receiving and analyzing results from the TD correlation circuit 126. Memory 104 may include any appropriate random-access memory (RAM) hardware.

Radar system 100 includes a transmit path having TX pulse train generator 111, beam former circuit 112, pulse shaper circuit 113, power amplifiers 114-116, and antenna array 117. The receive path includes low noise amplifier (LNA) 121, antenna element 127, TDC 123, registers 124, pulse train reconstruction and walk error adjustment circuit (reconstruction circuit) 125, and TD correlation circuit 126.

Although specific connection paths are not shown between the processor core 102 and the various other components in the transmit path and in the receive path, it is understood that the processor core 102 may control various components. Furthermore, some components may be integrated into the processor core 102, such as the pulse train generator circuit 111 and the registers 124, reconstruction circuit 125, and TD correlation circuit 126. In fact, the various components may be integrated in any appropriate manner.

Furthermore, the components of the radar system 100 may be implemented using any appropriate quantity of semiconductor dies. In one example, the processor core 102, memory 104, the transmit path, and the receive path may be implemented on a single semiconductor die. In another example, the radar system 100 may include multiple semiconductor dies, such as a single semiconductor die for the receive path, the processor core 102, and the memory 104 and a separate semiconductor die for the transmit path. In some instances, the amplifiers 114-116 and 121 as well as the antenna array 117 and antenna element 127 may either be implemented on a die with digital components or separately from the digital components as appropriate. In any event, the various semiconductor dies may be implemented within one or more semiconductor packages.

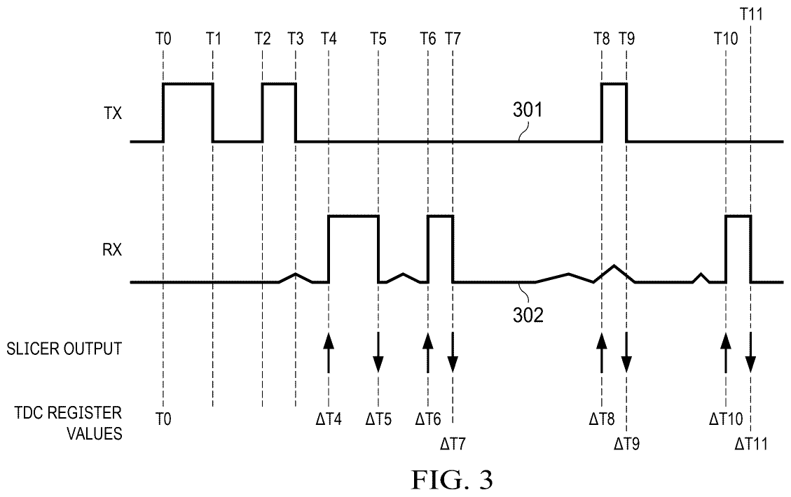

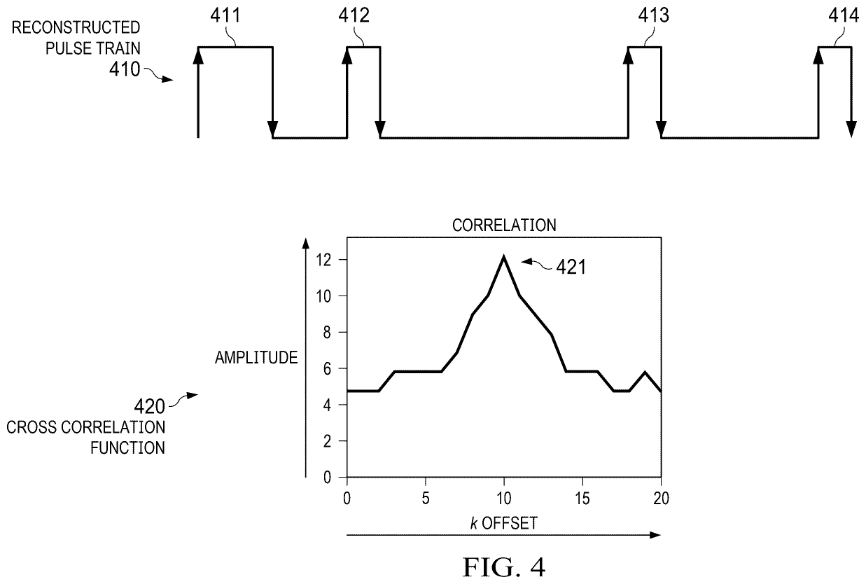

The pulse train generator circuit 111 may be configured to generate a pulse train to be transmitted via the power amplifiers 114-116 and antenna array 117. Pulse train examples are described in more detail with respect to FIGS. 3-4 below. The pulse train generator circuit 111 may be configured to generate any appropriate pulse train, where each pulse of the pulse train may include a rising edge and a falling edge. An example pulse train may include multiple pulses, where the pulses may each have a pseudorandom duration. In an example, the pulse train may appear as a random code with a low side lobe autocorrelation function.

The pulse train generator circuit 111 generates the pulse train and provides that pulse train to the beam former circuit 112, and the beam former circuit 112 may then pass the beam formed signal to the pulse shaper circuit 113. In one example, the beam former circuit 112 may include any appropriate hardware or software functionality. In one example, the beam former circuit 112 may create multiple copies of the pulse train and then apply a respective time domain delay to each of the copies of the pulse train. Although not shown in FIG. 1, beam former circuit 112 may include one or more TDCs, which are configured to perform digital processing on the copies of the pulse train to apply the respective time domain delays.

The pulse shaper circuit 113 may receive the beam formed pulse train copies from the beam former circuit 112 and may apply appropriate pulse shaping to each of the beam formed pulse train copies. In one example, there may be regulations regarding signal interference and spectrum use, where those regulations may prevent the transmission of unmodified pulse trains. Specifically, the sharp rising edges and falling edges of a pulse train may result in undesired emissions in prohibited portions of spectrum. Pulse shaper circuit 113 may be configured to modify the sharp rising edges and falling edges to reduce emissions in some parts of the spectrum in order to conform to regulations.

The power amplifiers 114-116 and antenna array 117 form a radio frequency (RF) front end in the transmission path. In an example in which there are three power amplifiers 114-116 and three antenna elements in the antenna array 117, there may be three beam formed copies of the pulse train, each of the copies corresponding to a respective power amplifier. The time delays from the beam former circuit 112, along with a spatial configuration of the antenna array 117, may result in an RF signal of the pulse train, where that RF signal has directional qualities. In other words, while there may be three beam formed copies of the pulse train, the resulting RF signal transmitted by the RF front end in the transmit path may include a directional pulse train signal.

While the transmit path is shown having three power amplifiers 114-116 and three antenna elements in the antenna array 117, it is noted that the RF front end may be implemented in any appropriate manner, whether having more or fewer antenna elements and more or fewer power amplifiers. The same is true of the RF front end in the receive path, which includes antenna element 127 and LNA 121. Specifically, while only one amplifier and antenna element is shown in the receive path, the RF front end in the receive path may be implemented with more or fewer amplifiers and antenna elements. In one example with multiple receive antennas, each of the receive antennas would be associated with a respective slicer, set of TDCs, and set of registers that output to a shared reconstruction circuit. In another example with multiple receive antennas, the entire receive path from slicer to TD correlation circuit may be repeated for each receive antenna.

During operation of radar system 100, the transmit path generates an RF signal, which travels through an air medium and may be reflected by one or more objects. The reflection of the RF signal may be received and processed by the receive path. Some examples of radar system applications may include automotive parking and driving aids, which may detect obstacles and other cars, medical applications which may detect presence or absence of a patient, and/or the like. In fact, the radar system 100 may be implemented in any appropriate application.

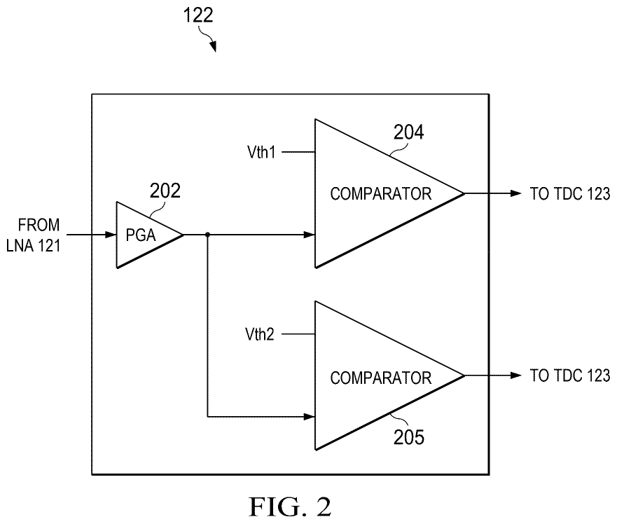

The RF signal may be reflected and travel through the air medium to be received by the antenna element 127 and LNA 121. LNA 121 may provide an appropriate amount of gain to the received signal and may then pass that received signal to the slicer circuit 122. Slicer circuit 122 is described in more detail with respect to FIG. 2. In short, the slicer circuit 122 may act as a noise filter and may generate a series of rising edges and falling edges, which may approximate the received signal. The received signal corresponds to the transmitted signal, which is a pulse train, though the received signal may be attenuated somewhat and may include noise components. The slicer circuit 112 may generate the series of rising and falling edges, which may be configured to be a reduced-noise version of the received signal.

The slicer circuit 112 outputs to the TDC 123. The TDC 123 uses a start signal from the transmit path to provide a reference time TO, and the TDC 123 may generate data which indicates times of received rising edges and falling edges relative to the reference time TO. The operation of the TDC is described in more detail with respect to FIG. 3. In some instances, the TDC 123 may include multiple TDCs, such as a first TDC (TDC 1) to generate time data for rising edges and a second TDC (TDC 2) to generate time data for falling edges. A given TDC may include any appropriate quantity of TDC components.

TDC 123 generates time data and writes that time data to registers 124. The reconstruction circuit 125 reads the time data from the registers 124 and reconstructs the pulse train. For instance, time domain portions between a rising edge and a falling edge may be assigned to be a digital one, and time domain portions between the falling edge and the subsequent rising edge may be assigned to be a digital zero. The resulting reconstructed pulse train may be a filtered and square-edged version of the received signal, having amplitude normalized to a value of digital one or zero, and perhaps having some amount of noise. Also, the reconstructed pulse train may include time data for some or all of the edges, such as relative to a reference time TO. Furthermore, the reconstruction circuit 125 may perform walk error adjustment. Reconstruction and walk error adjustment are described in more detail with respect to FIG. 4.

The reconstruction circuit 125 generates the reconstructed signal and passes the reconstructed signal to the TD correlation circuit 126. The TD correlation circuit 126 may perform, e.g., a cross-correlation function on the reconstructed pulse train and the original pulse train to determine a time-of-flight. In some examples, noise in the reconstructed signal may prevent the time data itself from the reconstruction circuit 125 from being used to determine time-of-flight, though the TD correlation circuit 126 may perform a correlation function that may provide acceptable results despite some amount of noise in the reconstructed pulse train.

An example correlation function may include a time domain cross-correlation function. An example cross-correlation function for two signals x1(n) and x2(n) may be given by Equation 1:

$$C [ k ] = {\sum }_{n} {x}_{1} [ n ] \cdot {x}_{2} [ n + k ] \qquad Eq . ( 1 )$$

In Equation 1, n is a discrete index that encodes time, k is a discrete lag value that encodes time. Where C[k] reaches its maximum value, that value of k indicates the time delay between the two signals. In this example, the time delay between transmitting the RF signal from the transmit side and receiving the received signal on the receive side may be referred to as time-of-flight. To perform a cross-correlation using Equation 1, the TD correlation circuit 126 may compute the cross-correlation over a variety of values for k to determine which value of k results in a maximum for C[k]. For instance, k=0 may correspond to a temporal offset between the reference time T0 and a first rising edge detected by TDC 123. In one example, the TD correlation circuit 126 may perform multiple calculations of Equation 1 to determine a value of k resulting in a maximum for C[k]. The TD correlation circuit 126 may then indicate that determined value of k to the processing core 102. The processing core 102 may then execute computer readable code to perform further analysis on the results, such as range measurement, speed measurement, angle measurement, and the like.

FIG. 2 is an illustration of an example implementation for slicer circuit 122, according to some embodiments. Slicer circuit 122 includes a first comparator 204, which receives a reference voltage level Vth1 at a first input and receives a gain-adjusted version of the received signal at a second input. The gain-adjusted version of the received signal is shown coming from LNA 121, through programmable gain amplifier (PGA) 202 and to the second input of the comparator 204. Comparator 204 is configured so that it outputs a high value (digital one) when the gain-adjusted received signal is above the reference value Vth1 and outputs a low value (digital zero) when the gain-adjusted received signal is below the reference value Vth1. The output, therefore, is a series of rising and falling edges, approximating the pulses (and noise) of the received signal.

In some implementations, the gain of the PGA 202 and the level of Vth1 may be set to any appropriate level so that a rising edge of the received signal would be expected to result in a rising edge output from comparator 204, and a falling edge of the received signal would be expected to result in a falling edge output from comparator 204. In some examples, the level of Vth1 may be set somewhere between an expected noise floor of the received signal and an expected high level of the received signal to detect rising edges. In some examples, the level of Vth1 may be set to be inclusive of all or nearly all rising edges, thereby allowing for detection of some noise, to avoid omitting pulses from the pulse train.

Further in this example, slicer circuit 122 includes additional comparator 205. Comparator 205 is configured similarly to comparator 204, though comparator 205 may use a different reference level Vth2. A higher level for Vth2 may result in detecting rising edges slightly later while detecting falling edges slightly sooner. By contrast, a lower level for Vth2 may result in detecting rising edges slightly sooner while detecting falling edges slightly later. Furthermore, the closer Vth2 gets to the noise floor, more noise would be expected to generate edges at the output of comparator 205.

The implementation of FIG. 2 may allow for processor core 102 to select the output from either comparator 204 or from comparator 205. For instance, processor core 102 may analyze the results of the TD correlation circuit 126 and determine that some amount of noise may be reduced by selecting either comparator 204 or comparator 205. Processor core 102 may then perform a function (e.g., multiplexer function) to choose one of comparator 204 or comparator 205.

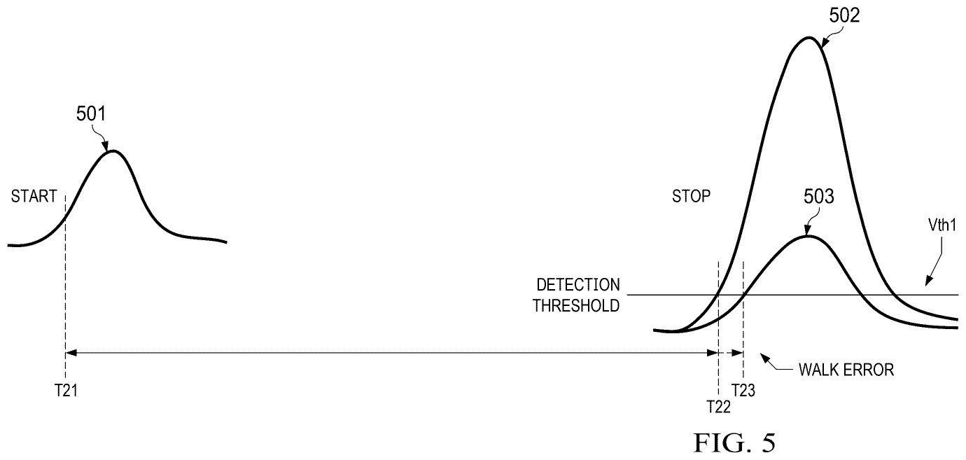

In another example, changes in the value of Vth1 and Vth2 may result in changes in the width of pulses output from slicer circuit 122. Furthermore, the width of a pulse may affect an amount of walk error in the signal. Processor core 102 may be configured to select among the output of comparator 204 and comparator 205 to adjust an amount of walk error. Walk error is described in more detail with respect to FIG. 5.

Various embodiments may include multiple comparators, such as comparators 204 and 205, having differently calibrated reference values, such as Vth1 and Vth2. And while the embodiment of FIG. 2 shows two comparators, it is understood that the scope of implementations may include any appropriate quantity of comparators, whether only a single comparator, two comparators, or more than two comparators.

FIG. 3 is an illustration of an example time domain operation, which may be performed by radar system 100 according to some embodiments.

The transmit path transmits pulse train 301, and the receive path receives a reflection, which is shown as received signal 302. The start signal corresponds with the reference time TO and the rising edge of the first pulse of pulse train 301. The start signal causes the TDC 123 to begin counting, so that the time data stored in the registers by the TDC 123 are relative times, reflecting time differences between detected events and the reference time TO.

Pulse train 301 includes a rising edge at time TO, a falling edge at time T1, and the beginning of a second pulse having a rising edge at time T2 and a falling edge at time T3. Furthermore, the pulse train 301 includes a third pulse having a rising edge at time T8 and a falling edge at time T9. The transmit path transmits the pulse train 301 through the air medium, such as described above with respect to FIG. 1. As noted above, the transmitted pulse train is transmitted on a directional signal and may include pulse shaping.

The pulse train 301 travels through the air medium and reflects from a target, traveling back toward the receive path. The receive path receives signal 302, which may include attenuation and noise effects. The receive path receives a first pulse having a rising edge at time T4 and a falling edge at time T5, a second pulse having a rising edge at time T6 and a falling edge at time T7, and a third pulse having a rising edge at time T10 and a falling edge at time T11. Furthermore, the received signal 302 may include noise, such as an illustrated noise spike between time T8 and time T9, where that noise spike does not correspond to any of the pulses of the pulse train 301.

The slicer circuit 122 may output a rising edge indication at time T4, which corresponds to the first rising edge of the received signal 302, and may output a falling edge indication at time T5, which corresponds to the first falling edge of the received signal 302. Similarly, the pulse received between times T6 and T7 causes the slicer to output a rising edge indication at time T6 and a falling edge indication at time T7. The rising edge and falling edge at times T4 and T5 are associated with a reflection of the first pulse of pulse train 301, and the rising edge and falling edge at times T6 and T7 are associated with a reflection of the second pulse of pulse train 301. In other words, the time difference between reference time T0 and time T4 is approximately equal to a time of flight of the transmitted signal. The rising edge and falling edge at times T10 and T11 are associated with a reflection of the third pulse of pulse train 301.

However, there is noise shown between times T8 and T9, which results in the slicer circuit 122 generating rising and falling edge indications at times T8 and T9.

The TDC 123 records time data, such as illustrated in FIG. 3. For instance, the TDC 123 may record time data delta T4, which indicates a difference between time T4 and reference time T0 and corresponds to the rising edge at time T4 of the received signal 302. Each of the different edges, both rising and falling edges, corresponds to a time difference between the reference time T0 and the particular edge. TDC 123 records “delta” data for each of the rising edges and falling edges. TDC 123 may write that time data to registers, such as registers 124.

FIG. 4 illustrates an example reconstructed pulse train 410, based on the received signal 302 of FIG. 3, according to some embodiments. Reconstructed pulse train 410 includes pulses 411-414. Pulse 411 corresponds to the first pulse between times TO and T1 of the transmitted signal 301 and the rising and falling edges at times T4 and T5 of the received signal 302. Similarly, pulse 412 corresponds to the second pulse between times T2 and T3 of the transmitted signal and the rising and falling edges at times T6 and T7 of the received signal 302. Pulse 414 corresponds to the third pulse between times T8 and T9 of the transmitted signal 308 and the rising and falling edges at times T10 and T11 of the received signal 302. The pulse 413 corresponds to noise in the received signal 302 and the rising and falling edges at times T8 and T9.

The reconstruction circuit 125 may generate the reconstructed pulse train 410 from the time data, written by the TDC 123 to the registers 124. For instance, for a time domain portion between time T4 and T5, the reconstruction circuit 125 may assign a value of digital one, thereby reconstructing pulse 411. For the time domain portion between time T5 and time T6, the reconstruction circuit 125 may assign a value of digital zero, thereby reconstructing the low portion between pulses 411 and 412. The reconstruction circuit 125 may then reconstruct the other pulses 412-414 with high and low portions in the same manner. The reconstruction circuit 125 may also assign one or more digital time values to the reconstructed pulse train, such as by assigning the rising edge of pulse 411 a time of delta T4. The digital time value may allow the TD correlation circuit 126 to set a value of k=0 for its time domain cross-correlation function.

FIG. 4 also shows example results 420 of a cross-correlation function, which may be performed by TD correlation circuit 126. For instance, the TD correlation circuit 126 may receive the originally transmitted pulse train from the transmit path and may also receive the reconstructed pulse train 410. The TD correlation circuit 126 may then overlay the original pulse train and the reconstructed pulse train 410 at a time domain position for k=0. The TD correlation circuit 126 may then perform a correlation function, such as TD cross-correlation, to provide results the same as or similar to example results 420. Results 420 show a graph with amplitude on the Y axis and time (offset of k) on the X axis. The spike 421 indicates a k value along the X axis at which C[k] is at a maximum. The spike 421, thus, corresponds to the time of flight of the RF signal that includes the pulse train 310. The TD correlation circuit 126 may then pass the results 420 to the processor core 102 for further processing.

FIG. 5 is an illustration of walk error, as it may be experienced on the receive path of radar system 100, according to some embodiments. Pulse 501 is an illustration of an example shaped pulse as it may be transmitted from the transmit path of the radar system 100, and the roundness may be exaggerated for ease of illustration. The reference time is shown as time T21 (which is analogous to reference time TO in the examples above). Pulses 502 and 503 are counterfactual examples of corresponding pulses as they may be received at a comparator (e.g., comparator 204) of the slicer circuit 122. The shapes of pulses 502 and 503 may be affected by attenuation in the air medium and in reflection of the target as well as by gain of amplifiers 121 and 202. For instance, pulse 502 has greater amplitude and, thus, may have experienced less attenuation and more gain than pulse 503.

While pulses 502 and 503 show effects of attenuation and gain, such effects may also cause changes in detected received time. For instance, the different shapes of pulses 503 and 502 would cause the rising edge of pulse 502 to be received before (time T22) the rising edge of pulse 503 (time T23), even though both pulses 502 and 503 show a maximum at a same time. The time between time T22 and time T23 is a time domain error, and it may be referred to as walk error.

Reconstruction circuit 125 may correct for walk error in the received signal 302. Reconstruction circuit 125 may correct for walk error in any appropriate manner and may adjust the reconstructed pulse train 410 to correct for the walk error. In one example, the reconstruction circuit 125 may compare a width of a pulse in the original pulse train from TX pulse train generator 111 to a width of a received pulse to determine the time domain error (walk error). The reconstruction circuit 125 may then add or subtract time domain width on either or both sides of the pulses in the reconstructed pulse train 410. For example, assuming a Ins transmitted pulse, if the received pulse in receive signal 302 is 800 ps wide, then the reconstruction circuit 125 may determine a time domain error of 200 ps. The reconstruction circuit 125 may then cause a 100 ps delay to be added to either side of the reconstructed pulse train 410 so rising edge is 100 ps early and falling edge is 100 ps late.

In another example, the reconstruction circuit 125 may compensate for skew between rising and falling edge slopes by estimating a constant for multiplying a width of a pulse. For example, if the skew causes a pulse of the received signal to be 80% of a width of a pulse in the original pulse train, then the reconstruction circuit 125 may then multiply the width of each of the pulses in the reconstructed pulse train 410 by the reciprocal of 80%. Thus, some embodiments may multiply a width of received pulses by a constant to correct an estimated error.

Additionally, or alternatively, the processor core 102 may select among different comparators in a slicer circuit to use output from a comparator that minimizes walk error.

Of course, the examples given above use specific numbers, though it is expected that other use cases may experience different walk error.

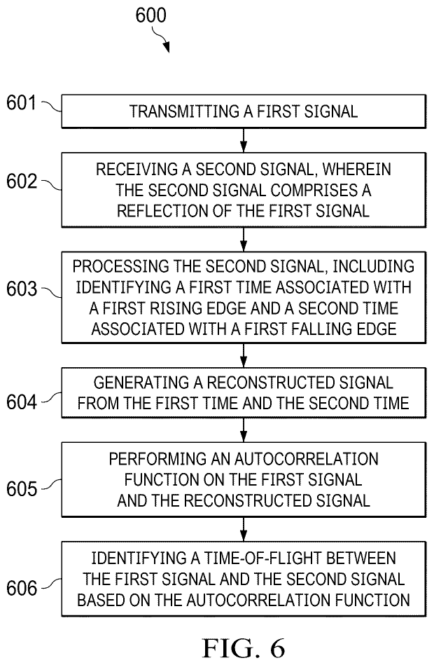

FIG. 6 is an illustration of example method 600, which may be performed by a system, such as the example radar system of FIG. 1, according to some embodiments. More specifically, the actions of method 600 may be performed by hardware logic and/or software logic or firmware logic.

Action 601 includes transmitting a first signal. An example of a first signal may include an RF signal from the transmit path of radar system 100, such as illustrated as pulse train 301 of FIG. 3. The RF signal may include a pulse train, and that pulse train may have experienced any appropriate processing to accommodate RF transmission, such as signal shaping and beam forming.

Action 602 includes receiving a second signal. In one example, the second signal may include a reflection of the first signal. An example of a second signal is described above as received signal 302 of FIG. 3.

Action 603 includes processing the second signal. For instance, the processing of action 603 may include identifying a first time associated with a first rising edge and a second time associated with a first falling edge. Action 603 may be performed by a TDC or multiple TDCs as appropriate. The example of FIG. 3 illustrates a TDC generating time data, which includes a time difference between a particular detected edge and a reference time, such as time TO. Such data may be digital data and may be saved to registers or other appropriate memory circuit.

Action 604 includes generating a reconstructed signal from the first time and the second time. An example is discussed above with respect to reconstruction circuit 125 and reconstructed pulse train 410 of FIG. 4. While action 604 refers to the first time and the second time, it is understood that a pulse train may include multiple pulses and that any appropriate quantity of edges and corresponding time data may be used to reconstruct the signal. The reconstructed signal may or may not include noise as a result of the transmitted signal traveling through the air medium and being reflected.

Action 605 includes performing a correlation function on the first signal and the reconstructed signal. An example correlation function may include a TD cross-correlation function, such as discussed above with respect to TD correlation circuit 126, Equation 1, and cross-correlation function 420 of FIG. 4.

Action 606 includes identifying a time-of-flight between the first signal and the second signal based on the correlation function. For instance, the example correlation function of Equation 1 may result in a value of k, which gives a maximum value of C[k]. That particular value of k may indicate a time-of-flight of the signal. The TD correlation circuit 126 may identify that value of k and then provide that value of k for further processing. For instance, the processor core 102 may then use the resulting k value for further processing, in some instances with other data, to determine range of a target, speed of a target, angle of the target, or any other appropriate radar function.

Actions 603-606 may provide advantages in some examples. For instance, actions 603-606 may employ one or more TDCs. Various embodiments that use TDCs may avoid nonlinear behavior associated with some analog-to-digital converters. As a result, some TDC implementations may allow for higher bandwidth operation, higher frequencies, and lower power consumption than other systems that use analog-to-digital converters instead of TDCs.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an analog-to-digital converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
transmitting a first signal;
receiving a second signal, wherein the second signal comprises a reflection of the first signal;
processing the second signal, including identifying a first time associated with a rising edge of the first signal and a second time associated with a falling edge of the first signal;
generating a reconstructed signal from the first time and the second time;
performing a time domain (TD) cross-correlation function on the first signal and the reconstructed signal; and
identifying a time-of-flight between the first signal and the second signal based on the TD cross-correlation function.

2. The method of claim 1, wherein processing the second signal includes:
inputting the second signal to a slicer;
generating, by the slicer, a third signal having a plurality of rising edges and a plurality of falling edges;
receiving the third signal at an input of a time-to-digital converter (TDC) circuit; and
generating, by the TDC circuit, data identifying the first time and the second time based on the third signal.

3. The method of claim 2, wherein the TDC circuit includes a first TDC and a second TDC, and wherein processing the second signal includes:
generating, by the first TDC, a first plurality of times based on rising edges, including the first time associated with the rising edge; and
generating, by the second TDC, a second plurality of times based on falling edges, including the second time associated with the falling edge.

4. The method of claim 1, wherein generating the reconstructed signal comprises performing a walk error correction on the rising edge and the falling edge.

5. The method of claim 4, wherein the walk error correction comprises adjusting the rising edge in a time domain and adjusting the falling edge in the time domain.

6. The method of claim 4, wherein the walk error correction is based on an estimated error, which includes a constant that may be multiplied by the second signal to result in a nominal pulse width.

7. The method of claim 1, wherein generating the reconstructed signal comprises applying a digital one value to a first time domain portion between the first time and the second time and applying a digital zero value to a second time domain portion subsequent to the second time.

8. The method of claim 1, wherein identifying the time-of-flight comprises identifying a peak in a result of the TD cross-correlation function.

9. The method of claim 1, further comprising:
generating a start signal coinciding with transmitting a first pulse of the first signal
starting a time-to-digital operation of a time-to-digital converter (TDC) based on the start signal; and
identifying the first time relative to the start signal and identifying the second time relative to the start signal according to the time-to-digital operation.

10. A system comprising:
a transmit path including:
a pulse train generator circuit configured to generate a first series of pulses; and
a first radio frequency (RF) circuit coupled to the pulse train generator circuit and configured to transmit a first signal based on the first series of pulses;
a receive path including:
a second RF circuit configured to receive a second signal that is in response to the first signal and that includes a second series of pulses;
a time-to-digital converter (TDC) circuit configured to generate time data, including first time data indicating rising edges of the second series of pulses and second time data indicating falling edges of the second series of pulses;
a pulse train reconstruction circuit configured to generate a third series of pulses based on the first time data and the second time data; and
a time domain (TD) cross-correlation function circuit configured to perform a TD cross-correlation function on the first series of pulses and the third series of pulses; and
a processor core configured to receive an output from the TD cross-correlation function and to determine a time-of-flight based on an output of the TD cross-correlation function circuit.

11. The system of claim 10, wherein the receive path further includes:
a comparator configured to receive a reference value and the second series of pulses and configured to output a high value in response to the second series of pulses being above the reference value at a given time and to output a low value in response to the second series of pulses being below the reference value at the given time.

12. The system of claim 11, wherein the TDC circuit is configured to generate the first time data from output of the comparator, including generating the first time data based on transitions from the low value to the high value and generating the second time data based on transitions from the high value to the low value.

13. The system of claim 12, wherein the TDC circuit includes a first TDC configured to generate the first time data and a second TDC configured to generate the second time data.

14. The system of claim 10, wherein the pulse train reconstruction circuit is configured to:
correct a time domain error in the time data; and
generate the third series of pulses, including assigning a digital one value to time domain portions between a rising edge and a subsequent falling edge and assigning a digital zero value to time domain portions between a falling edge and a subsequent rising edge.

15. The system of claim 10, further comprising:
a beam former circuit in the transmit path, wherein the beam former circuit is configured to receive the first series of pulses from the pulse train generator circuit, apply a set of time domain offsets via the TDC circuit, and to output the first series of pulses with the set of time domain offsets to the RF circuit.

16. A system comprising:
a time-to-digital converter (TDC) circuit configured to generate time data, including first time data indicating rising edges of a received series of pulses and second time data indicating falling edges of the received series of pulses;
a pulse train reconstruction circuit configured to generate an image of the received series of pulses based on the first time data and the second time data; and
a time domain (TD) cross-correlation function circuit configured to perform a TD cross-correlation function on a transmitted series of pulses and the image of the received series of pulses.

17. The system of claim 16, further comprising:
a processor core configured to receive an output from the TD cross-correlation function circuit and to determine a time-of-flight based on an output of the TD cross-correlation function circuit.

18. The system of claim 16, further comprising:
a comparator, configured to receive a radio frequency (RF) signal and a reference signal, the comparator further being configured to output a digital one in response to a level of the RF signal being above the reference signal and to output a digital zero in response to the level of the RF signal being below the reference signal,
wherein an output of the comparator comprises the received series of pulses.

19. The system of claim 16, wherein the pulse train reconstruction circuit is further configured to correct a time domain error in the received series of pulses by adjusting a rising edge in the image and adjusting a falling edge in the image.

20. The system of claim 16, wherein the TDC circuit comprises a first TDC configured to generate the first time data and comprises a second TDC configured to generate the second time data.
